(19) United States
(12) Patent Application Publication
(10) Pub. No.: US 2005/0148375 A1
(43) Pub. Date: Jul. 7, 2005

(54) APPARATUS FOR MOBILE TERMINAL DISPLAY

(75) Inventor: Jonathan DeLine, Morrisville, NC (US)

Correspondence Address: MOORE & VAN ALLEN PLLC, P.O. BOX 13706, Research Triangle Park, NC, 27709, US

(73) Assignee: SONY ERICSSON MOBILE COMMUNICATIONS AB, Lund (SE)

(21) Appl. No.: 10/708,433

(22) Filed: Mar. 3, 2004

Related U.S. Application Data
(60) Provisional application No. 60/533,525, filed on Dec. 31, 2003.

(51) Int. Cl. H04M 1/00

(52) U.S. Cl. 455/575.3; 455/575.1

(57) ABSTRACT

A mobile terminal for use in a wireless communication system comprises a housing encloses electronic components operable to transmit and receive telecommunication signals. The housing includes means for providing user input to the mobile terminal. A display is movably mounted to the housing for movement from a first position, where the display at least partially conceals the user input means of the housing, and a second position where the user input means of the housing is exposed and accessible to the user. A flip cover is pivotally mounted to the housing and movable between a closed position and an open position. The flip cover is sized to substantially conceal the display and an inner surface of the housing when in the closed position.

### BACKGROUND OF INVENTION

This invention relates generally to a mobile communication device, and more particularly to a mobile terminal used in a wireless communication system wherein the mobile terminal includes a display allowing users to view graphics and images.

A mobile terminal is used for sending and receiving information in a wireless communication system, such as a mobile telephone in a cellular telephone system. A mobile telephone typically includes a display and input mechanisms, such as keypads, buttons, and the like, which are used to control the mobile telephone. The display is used for viewing information and the input mechanisms typically provide for data entry, as well as control of any multi-media interface including the display.

With the growing popularity of the internet, mobile telephones are being used as receivers for not only voice data, but also various forms of visual data viewable on the display, such as e-mail, faxes or other forms of processed documents, pictures, videos or web pages. Some mobile telephones also function as a gaming device. However, as the various functions of a mobile telephone increase, so does the need for varying types of input mechanisms for each function. Unfortunately, users are usually restricted to one keypad layout that must suffice for multiple modes of use, such as making phone calls, gaming, and messaging.

As mobile telephones become smaller, less area is available for the input mechanisms. For ergonomic reasons, there is a limit below which it is undesirable to decrease the size and spacing of buttons and keys, especially keys within a keypad. One solution is to require keys to perform more than one function, as in so-called soft keys. However, the more functions assigned to multi-function keys, the more difficult and confusing a mobile telephone becomes to use. Thus, while the compactness of the mobile telephone is advantageous for portability with regard to ordinary voice communication, this diminishment in size creates a built-in disadvantage with respect to adding features and functions to the mobile telephone. For example, size limitations lead to difficulty in viewing the display while communicating over the mobile telephone or providing user input. Enlargement of the mobile telephone is not a solution, since increased size of the mobile telephone defeats the purpose of a compact, portable communication device.

For the foregoing reasons, there is a need for a mobile terminal for use in a wireless communication system which is adapted to efficiently accommodate multiple functions while maintaining compactness and portability.

### SUMMARY OF INVENTION

According to the present invention, a mobile terminal for use in a wireless communication system comprises a housing having an inner major surface and an opposed outer major surface and enclosing electronic components operable to transmit and receive telecommunication signals. The inner major surface of the housing includes means for providing user input to the mobile terminal. A display having an inner major surface and an opposed outer major surface is electrically connected to the electronic components in the housing. The display is movably mounted to the housing for movement from a first position, where the inner major surface of the display is opposite the inner major surface of the housing for at least partially concealing the user input means of the housing, and a second position where the user input means of the housing is exposed and accessible to the user. A flip cover having an inner major surface and an opposed outer major surface is also electrically connected to the electronic components in the housing. The inner major surface of the flip cover includes means for providing user input to the mobile terminal. The flip cover is pivotally mounted to the housing and movable between a closed position, where the inner major surface of the flip cover is opposite the outer major surface of the display when the display is in the first position, and an open position. The flip cover is sized to substantially conceal the outer major surface of the display and the inner major surface of the housing when in the closed position.

### BRIEF DESCRIPTION OF DRAWINGS

For a more complete understanding of the present invention, reference should now be had to the embodiments shown in the accompanying drawings and described below. In the drawings: FIG. 1 is a top plan view of a mobile terminal according to an embodiment of the present invention with the flip cover in an open position and the display abutting the housing.

FIG. 2 is an exploded view of a rotational joint for use in the mobile terminal shown in FIG. 1 according to the present invention.

FIG. 3 is a portion of a cross-section of the rotational joint shown in FIG. 2.

FIG. 4 is a top plan view of the mobile terminal shown in FIG. 1 with the display rotated relative to the housing and flip cover FIG. 5 is a top plan view of a mobile terminal according to another embodiment of the present invention with the flip cover in an open position and the display rotated relative to the housing and flip cover.

FIG. 6 is a side elevational view of a mobile terminal according to yet another embodiment of a mobile terminal according to the present invention with the flip cover in an open position and the display abutting the housing.

FIG. 7 is a side elevational view of the mobile terminal shown in FIG. 6 with the display abutting the flip cover.

FIG. 8 is a side elevational view of the mobile terminal shown in FIG. 6 with the display shown in a vertical position and in phantom at a position about midway between the position shown in FIG. 6 and the vertical position.

FIG. 9 is a side elevational view of the mobile terminal shown in FIG. 6 with the display in a vertical position and rotated relative to the housing and flip cover.

### DETAILED DESCRIPTION

Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the Figures. Indeed, the components may be oriented in any direction and the terminology, therefore, should be understood as encompassing such variations unless specified otherwise.

Referring now to the drawings, wherein like reference numerals designate corresponding or similar elements throughout the several views, a mobile terminal according to the present invention is shown in FIG. 1 and generally designated at 20. The mobile terminal 20 is adapted for use in a wireless communication network and, in the embodiment shown in FIG. 1, the mobile terminal 20 is a cellular telephone, which may be conventional except as otherwise provided in this description. The mobile terminal 20 comprises a housing 22 and a flip cover 24, which may be of any desired size and shape. The housing 20 contains electronic components that are operable to transmit and receive telecommunication signals, as is known in the art. The housing 20 includes an ear piece or speaker 28 for emitting sound and a display 30 for displaying alphanumeric text and other images. The flip cover 24 includes a mouthpiece 26 for inputting sound. The flip cover 24 is pivotally mounted to the housing 22 via a hinge assembly 32 for movement between a closed position and an open position, as is known in the art. The flip cover 24 is sized so that, in the closed position, the flip cover 24 substantially covers the display 30 and the inner surface of the housing 22. The method of connecting the flip cover 24 to the housing 22 is only generally described herein. Other methods of attaching a flip cover 24 are available, as is known in the art.

With the flip cover 24 in the open position (FIG. 1), a keypad 34 with standard alphanumeric and function input keys 36 is visible and accessible to the user on the inner surface of the flip cover 24. The flip cover keypad 34 is electrically connected to the appropriate components within the housing 22 so that the user can use tactile input to enter data, make telephone calls, interact with an image on the display, or otherwise control operation of the mobile terminal 20. It is understood that the term keypad as used herein is not limited to keypads based on contacting switch technology. Rather, “keypad” as contemplated by this disclosure is intended to refer to any type of input technology that might be referred to as such, including a non-contacting type more typically referred to as a touchpad in which the proximity of conductive bodies is sensed.

Various other user input devices (not shown) may also be provided on the mobile terminal 20. For example, a positioning device may control a position of a cursor element shown as an image on the display 30 for pointing and menu selection tasks. Suitable positioning devices include, but are not limited to, a track ball or a track pad. The positioning device can also be a plurality of directional indicators (not shown). By pressing a particular directional indicator button, the user controls the direction of movement of the cursor on the display 30. To enable the actual selection of an item which is under the cursor or otherwise highlighted, there can also be included one or more buttons, or other selectors, which can be used in conjunction with the pointing device.

Because there are many types of mobile terminal housings and associated components that are well known in the art and that may be utilized to practice the present invention, a more detailed description of these components is not required. It is understood that the present invention is not directed to any particular style of housing or mobile terminal.

A main processor and a memory control the overall operation of the mobile terminal 20 and are together referred to herein as a controller, as is known in the art. To facilitate the description, it is henceforth assumed that aspects of the present invention are generally carried out through the execution of software instructions in the mobile terminal 20. It is envisioned that these instructions may be written in the Java language or, alternatively, in C or C++. Note, however, that other languages may be substituted within the scope of the present invention. As is well known, Java is an application designed specifically for network connectable applications on consumer devices. The details of developing software in Java is well known to those skilled in the relevant art and are not required for an understanding of the present invention. Accordingly, such details are not provided herein. Certain embodiments of the present invention may be carried out by hardwired circuitry rather than by executing software, or by a combination of hardwired circuitry with software. Hence, it will be recognized that the present invention is not limited to any specific combination of hardware circuitry and software, nor to any particular source for software instructions.

The display 30 comprises a frame 38 having a central opening 40. An LCD panel 42 is fixed in the frame 38 and has a display surface exposed through the opening 40. The LCD panel 42 may be any of a number of commonly used built-in displays for cellular phones or other mobile terminals. The display 30 can be monochrome or color. The display 30 is electrically connected to the housing 22 for receiving image data from the controller.

The display 30 is centrally disposed on the housing 22 such that, with the flip cover 24 open and the display 30 in the position shown in FIG. 1, the display 30 conceals at least a portion of the inner surface of the housing 22. The display 30 is rotatably coupled to the housing 22 by a rotational joint 50 adjacent to the hinge assembly 32 along a central longitudinal axis of the mobile terminal 20.

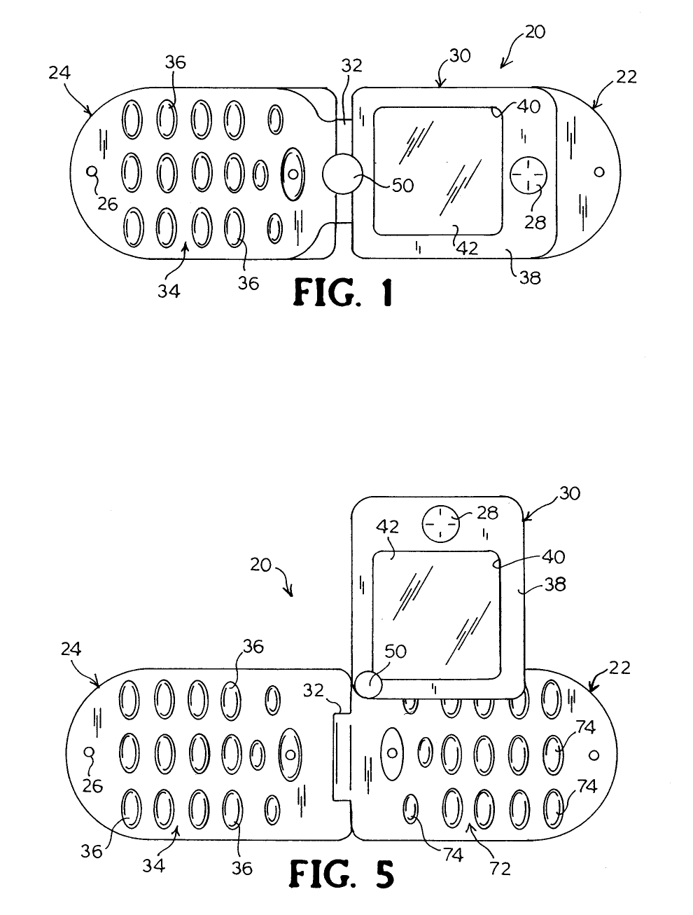

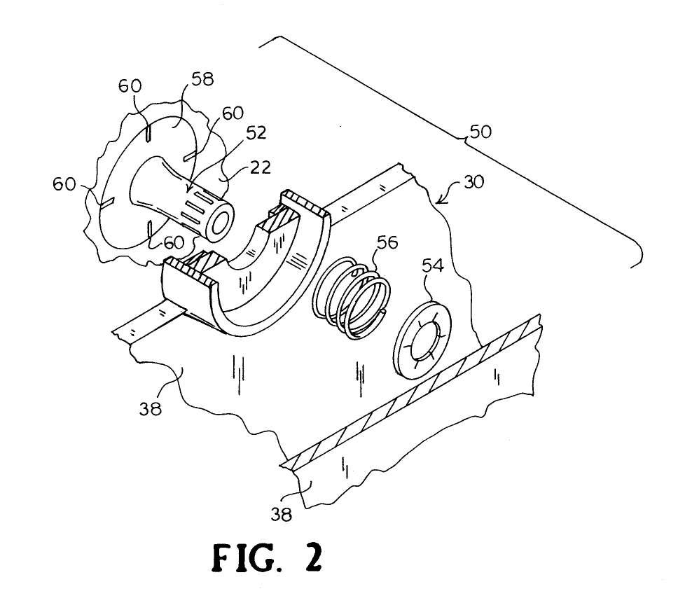

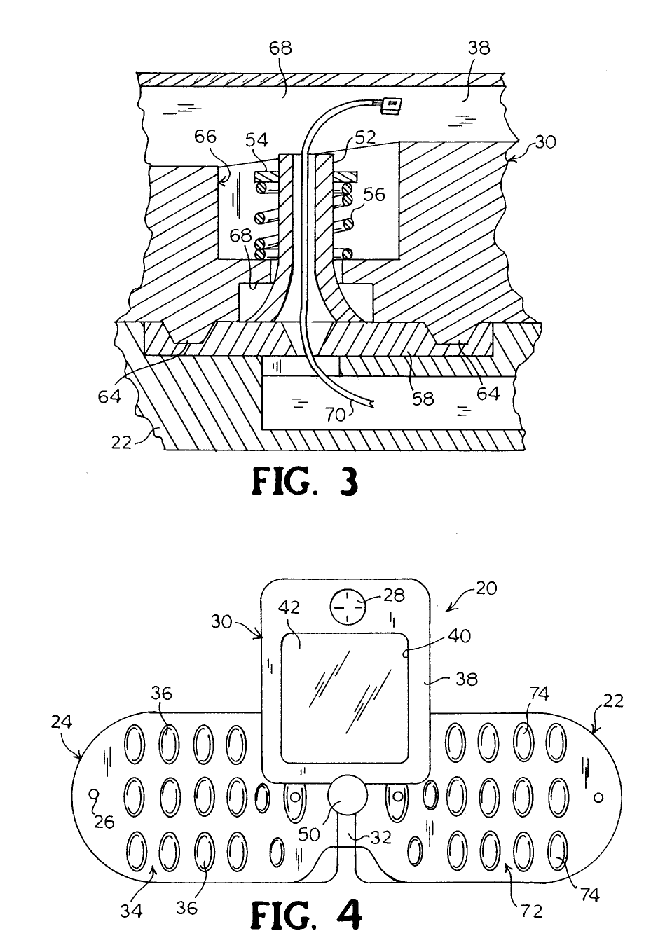

Referring to FIGS. 2 and 3, the rotational joint 50 comprises a hollow metal sleeve 52, a push nut 54, and a compression spring 56. The sleeve 52 has a circular flange 58 at one end. The periphery of the flange 58 has four circumferentially spaced radial detents 60. A portion of the end of the sleeve 52 opposite the flange 58 has splines 62 for fixedly receiving the push nut 54.

The flange 58 on the end of the sleeve 52 is molded into the outer surface of the housing 22 so that the sleeve 52 is fixed relative to the housing 22. The inner surface of the display frame 38 has a stepped opening 66 for receiving the sleeve 52 (FIG. 3). The detents 60 on the flange 58 receive spaced lugs 64, only two of which are shown in FIGS. 2 and 3, which extend inwardly from the inner surface of the display frame 38. The push nut 54 is forced onto the splines 62 at the end of the sleeve 52 so that the display 30 is fastened to the sleeve 52. The compression spring 56 surrounds the end of the sleeve 52 between a shoulder 68 in the opening 66 in the display and the push nut 54 for biasing the display 30 against the housing 22. The display 30 is free to rotate relative to the housing 22 and sleeve 52. Connecting wires 70 or cables pass from the housing 22 through the sleeve 52 and extend into the display frame 38 for electrically connecting the display 30 to the appropriate electronic components within housing 22. The connecting wires 70 may include multiple conductors for multiple circuits.

The rotational joint 50 allows the display 30 to rotate in a plane relative to the housing 22 about an axis perpendicular to the longitudinal axis of the mobile terminal 20. Initial rotation of the display 30 causes the lugs 64 to cam out of the detents 60 on the flange 58 at the end of the sleeve 52 against the force of the spring 56 acting on the display frame 38. Continued rotation of the display 30 will align the lugs 64 with other detents 60 on the flange 58. The rotational joint 50 provides a click function, producing a click feeling to the user when the lugs 64 slip into the detents 60 for releasably securing the display 30 in the new position. As seen in FIG. 2, the detents 60 are spaced 90 degrees apart so that the display 30 is releasably secured into a fixed position after each 90 degrees of rotation relative to the housing 22. It is understood that any number of detents 60 could be disposed about the periphery of the flange 58 so that several display 30 positions relative to the housing 22 would be provided. The display 30 can also be attached to the mobile terminal 20 such that the display 30 has both rotational and angular movement relative to the housing, as is known in the art.

FIG. 4 shows the mobile terminal 20 with the display 30 rotated 90 degrees from the display position shown in FIG. 1. With the display 30 in the rotated position, the inner surface of the housing 22 is now exposed revealing a keypad 72 with standard alphanumeric and function input keys 74. The housing keypad 72 is electrically connected to the appropriate components within the housing 22 so that the user can use tactile input to enter data, make telephone calls, interact with an image on the display, or otherwise control operation of the mobile terminal 20. In one embodiment, the housing keypad 72 may be the right side of a keyboard, like the right side of the English Qw-erty version.

Thus, a mobile terminal 20 according to the present invention allows the user to rotate the display 30 to a position revealing additional keys 74 on the housing 22. With the display 30 in this position, holding the mobile terminal 20 sideways will position the display 30 above the keypads 34, 72 and allow the user to use both hands to access the full keyboard in connection with, for example, the transmission of information, such as is the case when the user is using the mobile terminal 20 to compose or transmit a document or some other information. The user would also able to use both keypads 34, 72 to navigate through the displayed information, as well as to select or manipulate all or portions of the image being displayed, and the like.

In another embodiment of the present invention, shown in FIG. 5, the rotational joint 50 is spaced from the central longitudinal axis of the mobile terminal 20 to reveal more keys 74 on the housing keypad 72 when the display 30 is rotated 90 degrees.

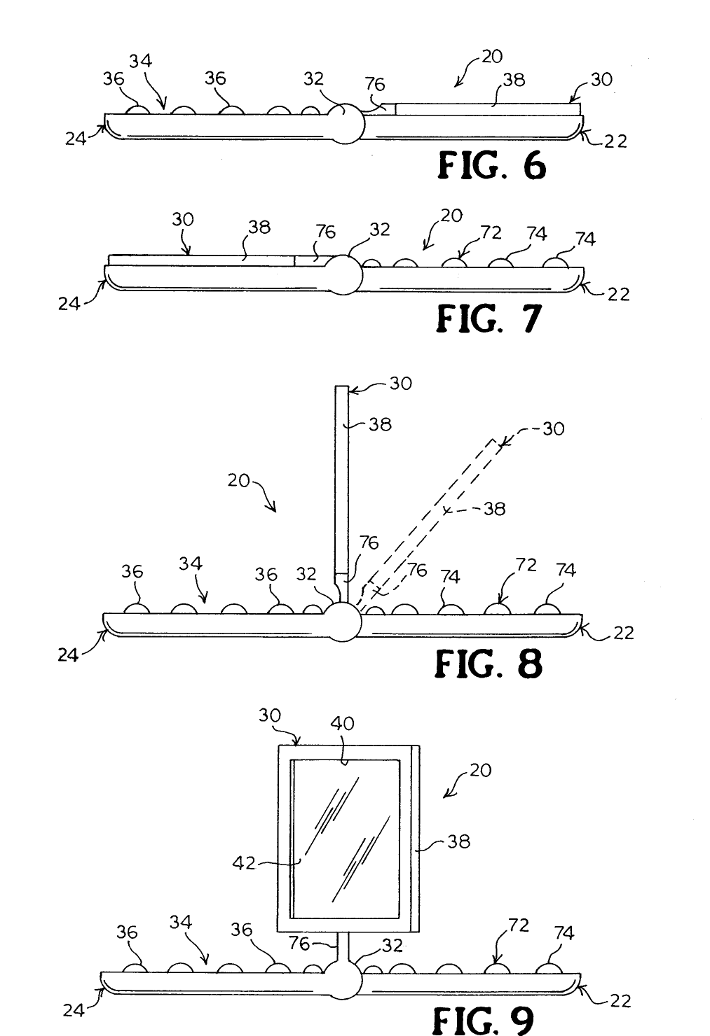

A third embodiment of a mobile terminal 20 according to the present invention is shown in FIGS. 6-9. The parts of this embodiment of the mobile terminal 20 which are identical to those of the mobile terminal 20 according to above embodiment are denoted by identical reference numbers and will not be described in detail below. In this embodiment, the display 30 is coupled to the hinge assembly 32 via a bracket 76 for pivotal movement between a first position shown in FIG. 6 and a second position shown in FIG. 7 when the flip cover 24 is in an open position. In the first position, the display 30 is against the inner surface of the housing 22. In the second position, the display 30 is against the inner surface of the flip cover 24.

The second position of the display 30 is reached after pivoting the display 30 about the hinge assembly 32 until the display 30 is approximately perpendicular to the housing 22 and flip cover 24 (FIG. 8). As shown in FIG. 9, the bracket 76 is adapted to allow at least 180 degree rotational movement of the display 30 relative to the housing 22 and flip cover 24 about a central longitudinal axis of the display 30 when the display 30 is positioned away from the inner surfaces of the housing 22 and flip cover 24. This allows the rear surface 39 of the display 30 to be seated against the housing 22 or flip cover 24 so that the screen 42 is visible for viewing in either the first or second position of the display 30.

In both the first and second positions of the display 30, one of the keypads 34, 72 is hidden behind the display 30. Thus, input may be selectively received from only one keypad 34, 72, depending on the position of the display 30. This means that only the flip cover keypad 34 or the housing keypad 72 would be enabled at any particular time and that the other keypad would be disabled, based on whether the display 30 is in the first position or the second position. A mechanism or means may be provided with the mobile terminal 20 for determining the position of the display 30. For example, a switch, relay or contact (not shown) could be operatively associated with the hinge assembly 32 and display 30. When the display 30 is moved, delivery of the user input signal would be automatically switched from one keypad to the other keypad. A sensor could also be used to enable the determination of the position of the display 30, such as a sensor which enables a mobile telephone 20 to answer calls upon opening the flip cover 24, as is known in the art. Because a keypad is effectively disabled when the display 30 is in either position since the respective keypad is concealed and inaccessible, this arrangement would reduce power consumption and prevent false key presses caused by handling the mobile terminal 20.

In keeping with the present invention, each of the keypads 34, 72 represents a different keypad layout that may be optimized for a particular function, such as making phone calls, gaming or messaging. The result is two different keypad layouts in one compact mobile terminal 20. The user can then select the preferred keypad layout and position the display 30 appropriately by pivoting and rotating the display 30 relative to the housing 22 and flip cover 24 for exposing the preferred keypad and concealing the other keypad behind the display 30. Thus, the present invention makes it possible to easily switch between the keypads 34, 72 depending on which is best suited for the situation and, therefore, increase the utility of the mobile terminal 20.

While the present invention is described herein in the context of the mobile terminal in the form of a mobile cellular telephone, it should be understood that the mobile terminal of the present invention is not so limited and may find utility in other electronics devices and applications that require a keypad or other input mechanism. For example, the term mobile telephone as used herein may include a cellular radiotelephone with or without a multi-line display; landline and cordless telephones; a Personal Communications System (PCS) terminal that may combine a cellular telephone with data processing, facsimile and data communications capabilities; a Personal Digital Assistant (PDA) that can include a radiotelephone, pager, Internet/intranet access, Web browser, organizer, calendar and/or a global positioning system (GPS) receiver; wristwatch keypad devices; and a conventional laptop and/or palmtop receiver or other computer system that includes a display. Mobile telephones may also be referred to as pervasive computing devices. In one embodiment of the present invention, the invention may be implemented on a computer system having a memory circuit for storage of data, a display which acts to generate images, and a control circuit that is configured to control the flow of data between the memory and receiver.

Although the present invention has been shown and described in considerable detail with respect to only a few exemplary embodiments thereof, it should be understood by those skilled in the art that I do not intend to limit the invention to the embodiments since various modifications, omissions and additions may be made to the disclosed embodiments without materially departing from the novel teachings and advantages of the invention, particularly in light of the foregoing teachings. For example, the present invention is suitable for use in a number of portable and non-portable electronics devices and applications. Accordingly, we intend to cover all such modifications, omission, additions and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A mobile terminal for use in a wireless communication system, comprising:
a housing having an inner major surface and an opposed outer major surface and enclosing electronic components operable to transmit and receive telecommunication signals, the inner major surface of the housing including means for providing user input to the mobile terminal;
a display having an inner major surface and an opposed outer major surface and electrically connected to the electronic components in the housing, the display movably mounted to the housing for movement from a first position where the inner major surface of the display is opposite the inner major surface of the housing for at least partially concealing the user input means of the housing and a second position such that the user input means of the housing is exposed and accessible to the user; and
a flip cover having an inner major surface and an opposed outer major surface and electrically connected to the electronic components in the housing, the inner major surface of the flip cover including means for providing user input to the mobile terminal, the flip cover pivotally mounted to the housing and movable between a closed position where the inner major surface of the flip cover is opposite the outer major surface of the display when the display is in the first position and an open position, the flip cover being sized to substantially conceal the outer major surface of the display and the inner major surface of the housing when in the closed position.

2. A mobile terminal for use in a wireless communication system as recited in claim 1, wherein the display is mounted to the housing for pivoting movement on the same axis as the pivoting movement between the housing and flip cover, wherein in the second position of the display the outer major surface of the display is opposite the inner major surface of the flip cover for at least partially concealing the user input means of the flip cover.

3. A mobile terminal for use in a wireless communication system as recited in claim 1, further comprising a hinge connecting the housing, the flip cover, and the display, the hinge providing the axis of movement of the housing, the flip cover and the display.

4. A mobile terminal for use in a wireless communication system as recited in claim 2, further comprising means for rotating the display interposed between the display and the pivotal mounting, the rotating means allowing the display to rotate in a direction perpendicular to the axis of the pivotal mounting for positioning one of the inner major surface or the outer major surface of the display against the inner major surface of the housing or the flip cover.

5. A mobile terminal for use in a wireless communication system as recited in claim 4, further comprising a hinge connecting the housing, the flip cover, and the display, the hinge providing the axis of movement of the housing, the flip cover and the display, and wherein the display rotating means is a movable support attached to the hinge and to an edge of the display.

6. A mobile terminal for use in a wireless communication system as recited in claim 1, further comprising a rotational joint mounted between the housing and the display for allowing the display to rotate in a plane about an axis perpendicular longitudinal axis of the housing.

7. A mobile terminal for use in a wireless communication system as recited in claim 6, wherein the display is mounted to the housing at a position along the longitudinal axis of the housing.

8. A mobile terminal for use in a wireless communication system as recited in claim 6, wherein the display is mounted to the housing at a position spaced from the longitudinal axis of the housing.

9. A mobile terminal for use in a wireless communication system as recited in claim 6, wherein the rotational joint allows the display to rotate by at least about 90 degrees.

10. A mobile terminal for use in a wireless communication system as recited in claim 1, wherein the user input means of the housing and the flip cover comprises a keypad apparatus disposed within the housing and the flip cover, the keypad apparatus also electrically connected to the electronic components in the housing so that tactile input can be received.
